(19) United States
(12) Patent Application Publication
(10) Pub. No.: US 2026/0120445 A1
(43) Pub. Date: Apr. 30, 2026

(54) HIGH-PERFORMANCE LOOSELY COUPLED MULTI-MODAL DATA FUSION SYSTEM FOR INTELLIGENT DRIVING ENVIRONMENT PERCEPTION SYSTEM, AND ON-BOARD EQUIPMENT

(71) Applicant: Jiangsu University, Zhenjiang, Jiangsu (CN)

(72) Inventors: Hai WANG, Zhenjiang, Jiangsu (CN); Cheng ZHANG, Zhenjiang, Jiangsu (CN); Yingfeng CAI, Zhenjiang, Jiangsu (CN); Long CHEN, Zhenjiang, Jiangsu (CN); Yicheng LI, Zhenjiang, Jiangsu (CN); Qingchao LIU, Zhenjiang, Jiangsu (CN); Guirong ZHANG, Zhenjiang, Jiangsu (CN); Haoran DONG, Zhenjiang, Jiangsu (CN)

(21) Appl. No.: 19/137,152

(22) PCT Filed: Jul. 31, 2024
(86) PCT No.: PCT/CN2024/108816

§ 371 Date: Jun. 9, 2025

(30) Foreign Application Priority Data
May 24, 2024 (CN) 202410654827.8

(51) Int. Cl. G06V 10/80; G01S 13/86; G01S 17/42; G06T 7/246; G06T 7/277; G06V 10/32; G06V 10/52; G06V 10/62; G06V 10/77; G06V 10/82; G06V 20/58; G06V 20/64

(52) U.S. Cl. CPC G06V 10/806; G01S 13/865; G01S 13/867; G01S 17/42; G06T 7/248; G06T 7/277; G06V 10/32; G06V 10/52; G06V 10/62; G06V 10/7715; G06V 10/82; G06V 20/58; G06V 20/64; G06T 2207/10028; G06T 2207/20084; G06T 2207/20221; G06T 2207/30196; G06T 2207/30241; G06T 2207/30252

(57) ABSTRACT

A high-performance loosely coupled multi-modal data fusion system for an intelligent driving environment perception system, and on-board equipment are disclosed in the present disclosure. The data fusion system includes a fusion detection model based on a modal-specific feature interaction strategy, configured to convert LiDAR point clouds, camera images, and millimeter-wave radar point clouds into unified bird's-eye view (BEV) features and perform multi-modal fusion; and a fusion tracking model based on a cascade coupling data association strategy of motion-appearance features, configured to perform subsequent trajectory tracking and matching based on feature information of the multi-modal fusion. A VoD dataset and a K-Radar dataset are selected for training, validating, and testing comprehensive performance of the models. An inference model is accelerated by applying TensorRT, to be quantified and deployed on an on-board computing test platform.

### TECHNICAL FIELD

The present disclosure belongs to the field of intelligent connected vehicle environment perception, and particularly relates to a high-performance loosely coupled multi-modal data fusion system for three-dimensional (3D) object detection and tracking tasks, and on-board equipment.

### BACKGROUND

With the gradual implementation of intelligent driving technologies, safe driving issues of intelligent connected vehicles have attracted increasing attention. Environment perception, as a primary task of an intelligent driving system, is a foundation and prerequisite for subsequent decision-making and planning, and task control and execution. Currently, an environment perception method based on multi-modal data fusion has gradually become the mainstream, and the perception method comprehensively perceives the surrounding environment through various types of on-board sensors such as a camera, a LiDAR, and a millimeter-wave radar. A fusion perception method is able to overcome shortcomings of a single sensor to some extent, achieve coordinated optimization and comprehensive processing of multi-sensor data, and enhance the adaptability of the environment perception system in complex traffic scenarios and severe weather conditions.

Different types of on-board sensors have different operating principles and own advantages and disadvantages. Camera images include dense color and texture information, but are easily affected by exposure, resulting in semantic distortion of the images. LiDAR point clouds are able to accurately depict three-dimensional (3D) structural information of the surrounding environment, but also have sparsity and randomness. The millimeter-wave radar has strong penetration ability and is almost unaffected by severe weather conditions, but also has problems such as low angular resolution, false alarm, and clutter interference. Only relying on information of a single modality inevitably leads to inaccurate perception in some scenarios. On the contrary, the perception method based on multi-modal data fusion is able to utilize effective information from camera images, LiDAR point clouds, and millimeter-wave point clouds to suppress interference of environmental noise and achieve accurate and reliable perception.

However, it is not easy to maximize the advantages of the multi-modal data fusion. Different sensors depict the environment in different ways, with significant differences. Simply fusing data of different modalities not only destroys original data structures and causes mutual interference, but also increases dimensionality of the data, resulting in a comprehension difficulty for a network. Therefore, scholars have conducted extensive exploration in the field of fusion perception, attempting to reveal an interaction mechanism between multi-modal data, thereby constructing more reasonable and effective fusion architecture. Up to now, mainstream feature-level and object-level fusion strategies have a problem of inefficient utilization for multi-modal complementary information, thereby seriously restricting the accuracy and reliability of detection and tracking tasks.

The feature-level data fusion strategy is widely applied in fusion detection tasks. This strategy first uses a backbone to perform feature extraction on multi-modal data, and then fuses resulting multi-modal feature maps. It is essentially hard association fusion of multi-sensor data, that is, concatenation and fusion of the multi-modal features. However, this method also has limitations. Due to the heterogeneity of multi-modal data, semantic information expressed by heterogeneous features at the same spatial position is not always consistent. Simply performing the hard association fusion on the multi-modal features will not only introduce a lot of environmental noise, but also suppress potential information included in a single modality to some extent.

The object-level fusion strategy is widely applied in tracking tasks. This strategy first performs data association on perception results of different sensors, and then performs state prediction using Kalman filtering. Although this fusion method is simple and intuitive, and is able to reduce uncertainty of a tracked object through multi-channel observations, it inevitably causes a large amount of information loss. On the one hand, this method ignores a large number of appearance features (color, texture, and shape features) provided by multi-modal features, and significantly increases the difficulty in data association. On the other hand, this method has not established an accurate motion model for the tracked object, and also leads to inefficient utilization of spatial motion information.

### SUMMARY

The present disclosure aims to overcome the shortcomings of the existing technical solutions and propose a high-performance loosely coupled multi-modal data fusion system and on-board equipment, thereby significantly improving the accuracy, robustness, and adaptability of an environment perception system in complex traffic scenarios and severe weather conditions, and ensuring the safe operation of intelligent connected vehicles under all operating conditions.

In order to achieve the above objectives, the present disclosure proposes a modal-specific feature interaction strategy, and a cascade coupling data association strategy of motion-appearance features. On the premise of fully considering heterogeneous characteristics of multi-source information, the representation ability and utilization of fusion features are significantly improved, thereby effectively leveraging on complementary fusion advantages of multi-modal data. The system setup mainly includes the following steps:
Step 1: Selecting a View of Delft (VoD) dataset including complex traffic scenarios and a K-Radar dataset including various severe weather conditions for training, validating, and testing comprehensive performance of the proposed method;
Step 2: Building a fusion detection model based on the modal-specific feature interaction strategy;
Step 3: Building a fusion tracking model based on the cascade coupling data association strategy of motion-appearance features; and
Step 4: Accelerating an inference model by applying TensorRT, to quantify and deploy on an on-board computing testing platform.

Specifically, the VoD dataset needs to be divided into a training set, a validation set, and a testing set proportionally according to traffic scenarios (such as a schoolyard, a suburb, an urban area, and an elevated road). The K-Radar dataset needs to be divided into a training set, a validation set, and a testing set proportionally according to weather conditions (such as cloudy, rainy, hazy, and blizzard). A dataset reference system is uniformly set as a vehicle coordinate system, with a coordinate origin set as an installation position of a millimeter-wave radar. A global scaling data augmentation method is adopted.

The fusion detection model based on the modal-specific feature interaction strategy includes a multi-modal feature extraction and bird's-eye view (BEV) feature generation module, a modal-specific object queries initialization module, and a multi-modal feature fusion module based on a deformable Transformer. The fusion detection model is constructed based on DETR architecture, and supervised training is performed using bipartite graph optimal matching cost.

The fusion tracking model based on the cascade coupling data association strategy of the motion-appearance features includes a consecutive-frame multi-modal appearance feature generation module, a first-level data association module based on multi-category multi-model state prediction, a second-level data association module based on multi-modal temporal memory appearance features, and a trajectory management module. The fusion tracking model adopts TBD architecture and does not require an additional appearance feature extractor.

A model quantification process includes weight pruning and model distillation. The model deployment is implemented based on nodes and communication functions provided by an ROS system.

The present disclosure has the following advantages.

The high-performance loosely coupled multi-modal data fusion architecture proposed by the present disclosure is able to effectively improve the accuracy and reliability of the intelligent driving environment perception system, and is compatible with almost all mainstream sensor deployment solutions.

The modal-specific feature interaction strategy proposed by the present disclosure is able to give full play to the advantages of multi-channel observation, achieve efficient complementary fusion of multi-source heterogeneous information, and significantly improve the performance of a fusion detection algorithm on the premise of retaining the potential information of a single modality.

The cascade coupling data association strategy of motion-appearance features proposed by the present disclosure is able to comprehensively consider spatial motion information and multi-modal appearance features, so as to improve the integrity and success rate of data association, and significantly improve the performance of a fusion tracking algorithm.

The multi-sensor fusion perception system proposed by the present disclosure is able to effectively respond to extreme working conditions such as complex traffic scenarios and severe weather conditions, thereby ensuring safe running of intelligent connected vehicles.

### BRIEF DESCRIPTION OF THE DRAWINGS

FIG. 1 is a diagram of high-performance loosely coupled multi-modal data fusion architecture for an intelligent driving environment perception system.

FIG. 2 is a flowchart of a fusion detection algorithm based on a modal-specific feature interaction strategy.

FIG. 3 is a schematic diagram of a modal-specific object queries initialization.

FIG. 4 is a schematic diagram of an encoder and a decoder based on multi-modal deformable attention.

FIG. 5 is a flowchart of a fusion tracking algorithm based on a cascade coupling data association strategy of motion-appearance features.

FIG. 6 is a schematic diagram of a quadratic nonlinear motion model.

FIG. 7 is a schematic diagram of a second-level data association module based on multi-modal temporal memory appearance features.

### DETAILED DESCRIPTION OF THE EMBODIMENTS

In order to clarify the purpose and technical solution of the present disclosure, the specific embodiments of the present disclosure will be further described in detail below with reference to the accompanying drawings of the specification.

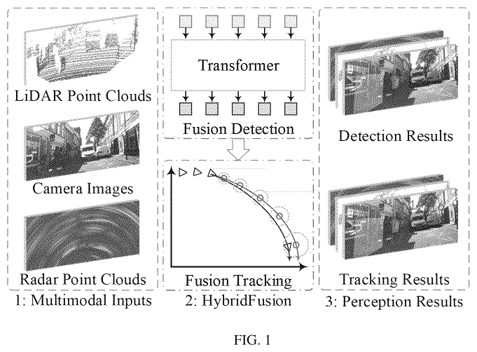

As shown in FIG. 1, high-performance loosely coupled multi-modal data fusion architecture for an intelligent driving environment perception system of the present disclosure includes a fusion detection model and a fusion tracking model cascaded together. The present disclosure is compatible with multi-source heterogeneous information provided by mainstream on-board sensors such as a LiDAR, a visible-light camera, and a millimeter-wave radar, and outputs accurate and reliable 3D object detection and tracking results. The implementation of a high-performance loosely coupled multi-modal data fusion system for an intelligent driving environment perception system of the present disclosure mainly includes the following steps:
Step 1: A fusion detection model based on a modal-specific feature interaction strategy is constructed.

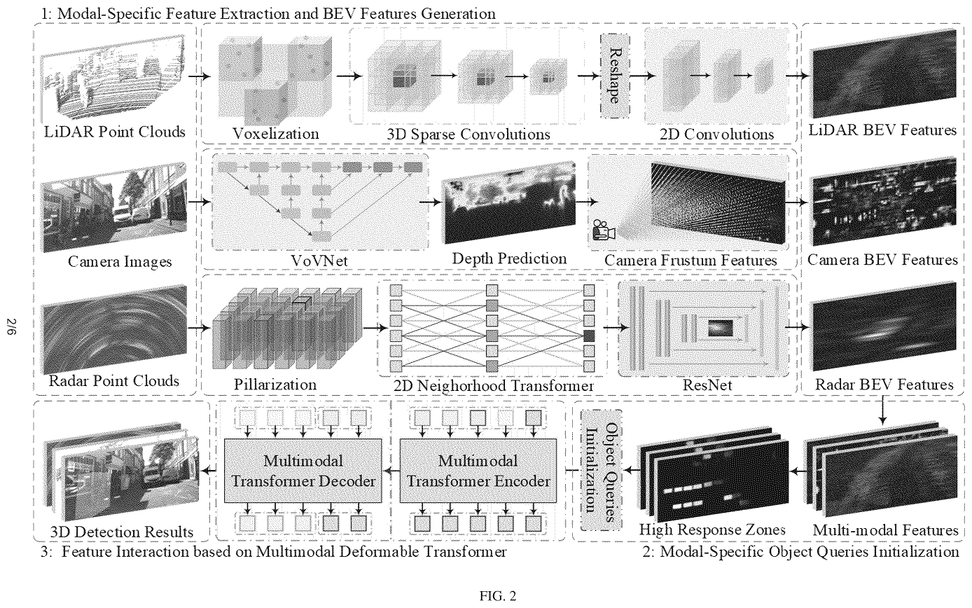

As shown in FIG. 2, overall architecture of the fusion detection model based on the modal-specific feature interaction strategy proposed by the present disclosure includes a multi-modal feature extraction and BEV feature generation network, a modal-specific object queries initialization model, and a multi-modal feature fusion model based on a deformable Transformer.

First, the multi-modal feature extraction and BEV feature generation network is constructed. Different sensors represent environmental information in different forms. The LiDAR outputs high-resolution 3D point cloud information, the camera describes the environment through foreground images, and the millimeter-wave radar usually uses continuous wave frequency signals. To avoid semantic differences caused by heterogeneous sensor information and unify the representation form of the environmental information, the present disclosure transforms multi-modal features into a shared BEV space. In addition, to ensure the universality and compatibility of the overall architecture, the multi-modal information remains independent of each other during feature extraction.

Specifically, LiDAR point clouds are processed by applying a voxelization method. First, original point clouds are subjected to dynamic voxelization, and step-by-step feature extraction is performed by using 3D sparse convolution to obtain 3D voxel features. Non-empty voxel features are then compressed in a height direction. Finally, feature extraction is performed by using 2D convolution to obtain dense point cloud BEV features F_{lid}. The above process is expressed as:

$${F}_{lid} = Voxelize ( {PC}_{lid} ) ◦ SPConv ◦ Aggn ◦ Conv \qquad ( 1 )$$

In the equation, ∘ represents a cascade operation, and PC_{lid} represents the original LiDAR point clouds. Voxel, SPConv, Aggn, and Conv represent the dynamic voxelization, the 3D sparse convolution, feature aggregation, and the 2D convolution, respectively.

Due to the lack of far-range depth information, converting camera foreground images into BEVs is not a simple task. Currently, most methods attempt to use the powerful dynamic encoding capability of a Transformer to learn mapping relationships from foreground views to BEVs, so as to construct relatively accurate BEV features. However, these dense prediction methods often impose a heavy burden on the network. However, in a multi-modal method, a network does not make inferences only based on single-modal information, and this means that a certain amount of information loss is acceptable. Therefore, the present disclosure constructs a lightweight image BEV feature generation network to enhance the real-time performance of the method. First, a VoVNet is used to perform feature extraction on the images to obtain multi-scale image features. Then, a Lift network is used to predict discrete depth distribution of the features and convert the features into discretized frustum features. Finally, height information is compressed using frustum pooling to obtain image BEV features F_{cam}. The above process is expressed as:

$${F}_{cam} = VoVNet ( Img ) ◦ DepthPred ◦ PillarPool \qquad ( 2 )$$

In the equation, Img represents the image of a multi-view visible-light camera; and VoVNet, DepthPred, and FrustPool represent a VoVNet-57 feature extraction backbone, a Lift depth prediction network, and a frustum pooling kernel, respectively.

Due to the fact that discrete depth estimation is able to only predict rough depth information, the image BEV features here are only used to implicitly reveal existence of an object, and remaining modal information will be further supplemented in the future.

With the increasing maturity of 4D imaging radar technology, it is also increasingly applied in the field of environment perception. Compared to a traditional millimeter-wave radar, a 4D imaging radar is able to not only provide height information, but also significantly improve angular resolution. A millimeter-wave radar point cloud obtained after signal processing has a higher confidence level and is denser. Therefore, the feature extraction method of the LiDAR point clouds is also able to be used to process 4D radar point clouds. In spite of this, the density of the 4D radar point clouds is still much lower than that of the LiDAR point clouds. In order to capture interaction relationships between the sparse millimeter-wave radar point clouds as much as possible, the present disclosure introduces a neighborhood Transformer to serve as a backbone network. First, original radar point clouds are converted into 2D pseudo images by pillarization. The neighborhood Transformer is then used to perform feature extraction to obtain dense radar features. Finally, a ResNet is used to adjust scales of the dense radar features so that the dense radar features maintain spatial semantic consistency with LiDAR features, thereby obtaining millimeter-wave radar BEV features F_{rad}. The above process is expressed as:

$${F}_{rad} = Pillarize ( {PC}_{r a d} ) ◦ NAT ◦ ResNet \qquad ( 3 )$$

In the equation, PC_{rad} represents the millimeter-wave radar point cloud. Pillarize, NAT, and ResNet represent the pillarization, a neighborhood Transformer feature extraction backbone, and a residual backbone network, respectively.

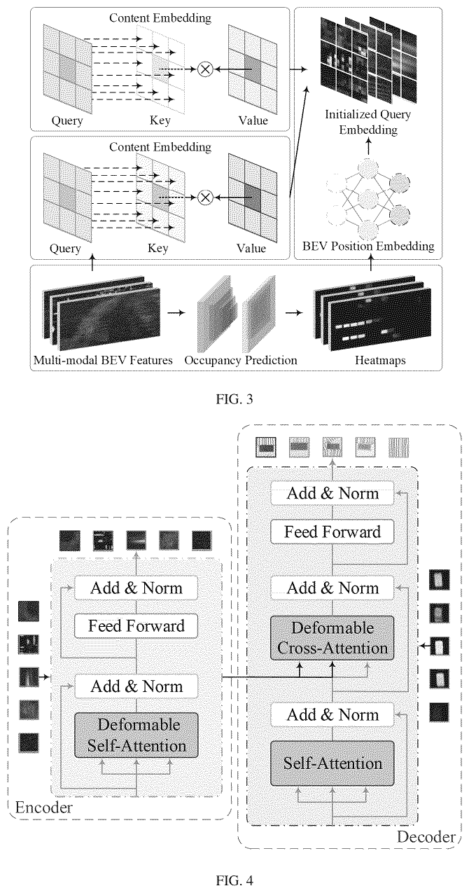

Furthermore, the modal-specific object queries initialization model is established. Original DETR architecture optimizes randomly initialized object queries step by step through a plurality of Transformer decoder layers. Subsequent researches have shown that initial object queries including dense prior information are able to effectively reduce optimization difficulty and improve final performance of a detector. Therefore, the current mainstream fusion detection methods mostly adopt a simple and intuitive strategy, that is, using a high response zone in a multi-modal feature map as an initial object query. However, this strategy is not always reasonable. When features of different modalities have inconsistent semantic information, a semantic conflict is caused and lead to potential information in a modality being submerged in a large amount of environmental noise. Different from the above strategy, the present disclosure considers potential object information provided by features of all modalities as candidate zones, and the specific implementation method is shown in FIG. 3. First, the multi-modal BEV features obtained previously is parallelly fed into an occupancy prediction network to obtain multi-modal heatmaps. The multi-modal BEV features and the multi-modal heatmaps are only stacked in form and remain independent of each other during processing. Next, by setting a threshold, high response zones with confidence levels higher than the threshold in the multi-modal heatmaps are selected to be regarded as candidate zones, and the candidate zones, during construction of object query embedding, are further classified into position embedding and content embedding. The multi-modal candidate zones include spatial position information of potential objects, and the spatial position information is encoded into the position embedding through a multi-layer perceptron structure designed in the present disclosure. The above process is expressed as:

$$PE = Concat ( {F}_{lid} , {F}_{c a m} , {F}_{r a d} ) ◦ OccPred ◦ MLP \qquad ( 4 )$$

In the equation, F_{lid}, F_{cam}, and F_{rad} represent LiDAR point cloud BEV features, multi-view camera image BEV features, and millimeter-wave radar BEV features, respectively. Concat, OccRed, and MLP represent a concatenation operation, an occupancy grid prediction network, and the multi-layer perceptron, respectively.

The construction of the content embedding is more skillful. Specifically, a modality of the candidate zones is defined as a primary modality, other two modalities are defined as secondary modalities. First, corresponding multi-modal BEV features are indexed based on coordinates of the candidate zones. Two attention mechanisms are then used in parallel to process features of the secondary modalities, where a feature of the primary modality is used as an object query, and the features of the secondary modalities are used as keys and values. By global matching of the object query with the keys, potential effective information in the secondary modalities is selected. Finally, the content embedding is obtained by stacking a primary feature and processed secondary features and then performing dimensionality reduction mapping.

Initial object query embedding QE is obtained by element-wise addition performed on the obtained position embedding and content embedding.

The above process is expressed as:

$${F}_{{s}_{1}} = softmax ( \frac{{Q}_{m} {K}_{{s}_{1}}^{T}}{\sqrt{d}} ) {V}_{{s}_{1}} , {F}_{{s}_{2}} = softmax ( \frac{{Q}_{m} {K}_{{s}_{2}}^{T}}{\sqrt{d}} ) {V}_{{s}_{2}} \qquad ( 5 )$$

$$CE = Concat ( {F}_{m} , {F}_{{s}_{1}} , {F}_{{s}_{2}} ) ◦ FFN \qquad ( 6 )$$

$$QE = CE + P E \qquad ( 7 )$$

In the equations, Qₘ represents the object query of the primary modality, and Kₛ₁, Kₛ₂, Vₛ₁, and Vₛ₂ represent the keys and the values of the other two secondary modalities, respectively; Fₘ represents the feature of the primary modality, and Fₛ₁ and Fₛ₂ represent the features obtained for the secondary modalities; softmax represents a multi-class exponential function; CE, PE, and QE represent the content embedding, the position embedding, and the object query embedding, respectively; and FFN represents a feed forward neural network, and d represents a feature dimension of an embedding vector.

Due to the fact that results of multi-channel observations in a close-range scenario are often consistent, object queries exhibit partial redundancy and overlap. On the one hand, the number of the object queries should be more than the maximum number of objects in the scenario, thereby reserving a certain number of negative samples without objects. On the other hand, overlapping object queries is also able to alleviate the problem of missed detections in highly occluded scenarios to some extent. It is undeniable that the modal-specific method proposed by the present disclosure preserves the potential object information provided by the multi-channel observations as much as possible.

Finally, the multi-modal feature fusion module based on the deformable Transformer is established. During decoding, it is necessary to provide complete environment features to further optimize the initial object query. For this reason, most methods attempt to obtain comprehensive environment feature representations through multi-modal feature fusion. However, in order to fully utilize the potential information in the features of all modalities, the present disclosure does not perform substantial multi-modal feature fusion in the initialization of modal-specific object queries. Therefore, a plain idea is directly stacking and fusing multi-modal feature maps. In fact, this is a simple and crude approach. On the one hand, high-dimensional heterogeneous features after fusion interfere with each other, making it difficult for the network to understand. On the other hand, the stacking operation does not perform data selection, and the multi-modal features after fusion are often too redundant, thereby causing a huge burden on the network. Therefore, the present disclosure constructs a lightweight multi-modal Transformer encoder based on deformable attention, so as to achieve efficient feature fusion, and a specific structure is shown in FIG. 4. First, the multi-modal BEV features obtained previously are stacked. The multi-modal BEV features are then further selected and integrated by using an encoder proposed in the present disclosure to obtain lightweight multi-modal fusion features.

Further, the detailed structure of the encoder proposed in the present disclosure is shown by an Encoder part in FIG. 4. The present disclosure promotes the deformable attention to the multi-modal field, and designs the multi-modal deformable attention. On the basis of the deformable attention, the present disclosure adds modality dimensions. That is, adaptive weighted summation is performed on sample features of all modalities, thereby aggregating multi-modal features. Multi-modal deformable attention is expressed as:

$$MMDeformAttn ( {p}_{q} , {F}_{c o m} ) = {\sum }_{i = 1}^{N} {W}_{i} [ {\sum }_{m = 1}^{M} {\sum }_{k = 1}^{K} {A}_{imqk} \cdot {W}^{′} {F}_{c o m} ( {p}_{q} + Δ {p}_{imqk} ) ] \qquad ( 8 )$$

In the equation, p_{q} and F_{com} represent normalized sampling point coordinates and multi-modal stacked BEV features, respectively; Wᵢ and W′ represent a normalized weight of multi-branch attention and a normalized sampling point weight, respectively; i, m, and k represent a multi-branch attention sequence number, a modality sequence number, and a sampling point sequence number, respectively; and N, M, and K represent a total number of branches of the multi-branch attention, a total number of modalities, and a total number of sampling points, respectively. Δp_{imqk} and A_{imqk} represent a sampling point offset and a BEV feature weight of a corresponding sequence number combination, respectively, and the weights need to be globally normalized.

The design of the decoder follows the original Transformer architecture, and the detailed structure is shown by a Decoder part in FIG. 4. Core modules of the decoder are self-attention and cross-attention. The self-attention is only used for interaction between object queries, and essentially the entire process does not involve the fusion of multi-modal information. The present disclosure sets the self-attention as an original self attention mechanism. The cross-attention is used for interaction between object queries and multi-modal fusion features, and its performance directly affects the efficiency of the object queries in utilizing the multi-modal fusion features. The present disclosure sets the cross-attention as an original deformable attention, and facilitates the object queries to capture effective information in the fusion features. The entire process is expressed as:

$$DeformAttn ( {z}_{q} , {p}_{q} , {F}_{fus} ) = {\sum }_{i = 1}^{N} {W}_{i} [ {\sum }_{k = 1}^{K} {A}_{iqk} \cdot {W}^{′} {F}_{fus} ( {p}_{q} + Δ {p}_{iqk} ) ] \qquad ( 9 )$$

In the equation, z_{q} and F_{fus} represent the initialized object query feature and the obtained lightweight BEV feature, respectively; and Δ_{iqk} and Δp_{iqk} represent the weight and sampling point offset of the multi-modal BEV feature corresponding to the sequence number combination, respectively.

The decoder outputs the optimized object query and predicts a final confidence and 3D bounding box information through feed forward.
Step 2: The fusion tracking model based on a cascade coupling data association strategy of motion-appearance features is constructed.

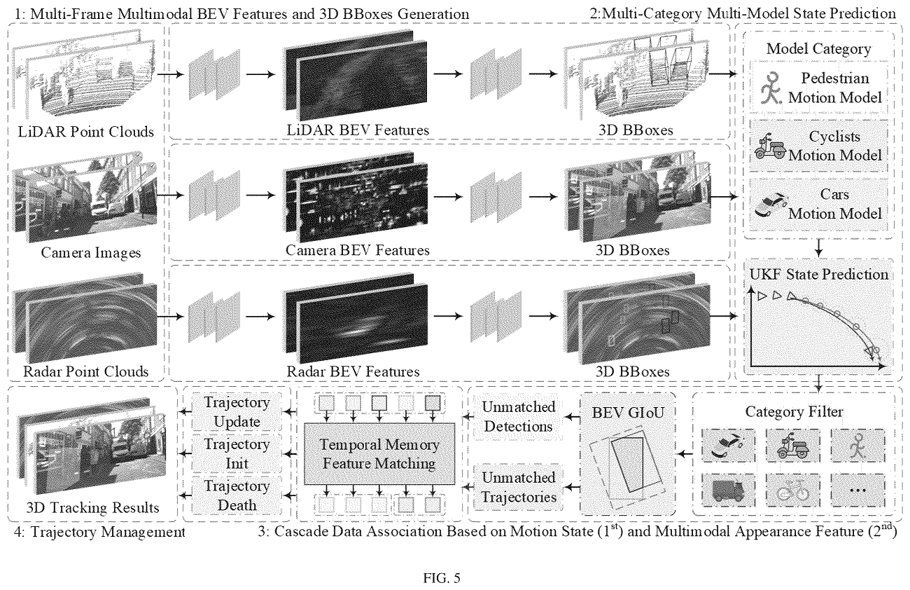

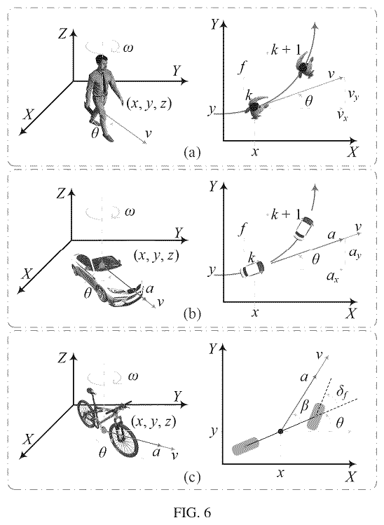

The overall architecture of the fusion tracking model based on the cascade coupling data association strategy of motion-appearance features proposed by the present disclosure is shown in FIG. 5, and includes a consecutive-frame multi-modal appearance feature generation module, a first-level data association module based on multi-category multi-model state prediction, a second-level data association module based on multi-modal temporal memory appearance features, and a trajectory management module. The fusion tracking model receives consecutive-frame information provided by a detection model, for performing subsequent trajectory tracking. The tracking model and the detection model share the multi-modal feature extraction and BEV feature generation module, that is, the consecutive-frame multi-modal appearance feature generation module is the same as the multi-modal feature extraction and BEV feature generation module.

First, the first-level data association model based on multi-category multi-model state prediction is established. There are clear physical and regulatory constraints in the real world, and therefore, a motion state of an object in a world coordinate system is not change suddenly and is able to be observed and predicted. The vast majority of 3D object tracking methods predict the motion state of the object in future frames by using linear motion models. However, in real traffic scenarios, movements of most traffic participants exhibit a high degree of nonlinearity. Obviously, simple linear models cannot accurately reflect motion characteristics of the tracked object. Even if a multi-channel observation model is able to provide complete motion parameters for the current frame, it is difficult to accurately predict future states based on incomplete motion models, resulting in inefficient utilization of spatial motion information. Therefore, the present disclosure introduces a plurality of quadratic nonlinear motion models to establish accurate motion models for different categories of traffic participants.

Specifically, based on the statistical distribution pattern of the motion characteristics of traffic participants, the quadratic motion model with the highest adaptability is selected. As shown in FIG. 6, the present disclosure introduces a Constant Turn Rate and Velocity (CTRV) model, a Constant Turn Rate and Acceleration (CTRA) model, and a cyclists motion model. The CTRV model assumes that the object moves along a straight line and is also able to move at a fixed turn rate and a constant velocity. The CTRV model considers that a velocity direction and a heading angle of the object are always consistent with each other, and is able to comprehensively reflect motion characteristics of pedestrians, as shown in FIG. 6(a). A state transition equation of a pedestrian trajectory is represented as:

$${}_{}^{CTRV} {X}_{k + 1}^{} = {}_{}^{CTRV} {X}_{k}^{} + [ \begin{matrix}\frac{v}{ω} [ sin ( {θ}_{k} + ω {T}_{k} ) - sin ( {θ}_{k} ) ] \\ \frac{v}{ω} [ cos ( {θ}_{k} ) - cos ( {θ}_{k} + ω {T}_{k} ) ] \\ ω {T}_{k} \\ 0 \\ 0\end{matrix} ] \qquad ( 10 )$$

In the equation, ^{CTR}VX represents a state parameter of a pedestrian motion model, θ, ν, and ω represent a heading angle of a car, a car velocity, and an angular velocity, respectively, Tₖ represents a time interval, the subscript k represents a time k, and the subscript k+1 represents a time k+1.

The CTRA model is a further development on the basis of the CTRV model, and assumes that the object moves at a fixed turn rate and a constant acceleration. In addition, the CTRA model considers that an acceleration direction, a velocity direction, and a heading angle of the object are always consistent with one another. The CTRA model introduces the acceleration variable, and thus has motion characteristics more in line with car objects, such as cars and trucks, as shown in FIG. 6(b). State variables and a state transition equation of a car object trajectory is represented as:

$${}_{}^{CTRA} {X}_{k + 1}^{} = {}_{}^{CTRA} {X}_{k}^{} + [ \begin{matrix}{g}_{x} ( {x}_{k} , {T}_{k} ) \\ {g}_{y} ( {x}_{k} , {T}_{k} ) \\ ω {T}_{k} \\ {aT}_{k} \\ 0 \\ 0\end{matrix} ] \qquad ( 11 )$$

$${g}_{x} ( {x}_{k} , {T}_{k} ) = \frac{a [ cos ( {θ}_{k} + ω {T}_{k} ) - cos ( {θ}_{k} ) ]}{{ω}^{2}} + \frac{( {v}_{k} + a {T}_{k} ) sin ( {θ}_{k} + ω {T}_{k} ) - {v}_{k} sin ( {θ}_{k} )}{ω} \qquad ( 12 )$$

$${g}_{y} ( {x}_{k} , {T}_{k} ) = \frac{a [ sin ( {θ}_{k} + ω {T}_{k} ) - sin ( {θ}_{k} ) ]}{{ω}^{2}} - \frac{( {v}_{k} + a {T}_{k} ) cos ( {θ}_{k} + ω {T}_{k} ) - {v}_{k} cos ( {θ}_{k} )}{ω} \qquad ( 13 )$$

In the equations, ^{CTRA}X represents a state parameter of the cars motion model, gₓ(xₖ,Tₖ) and g_{y}(xₖ, Tₖ) represent intermediate variables, and a represents an object acceleration.

The cyclists motion model has a higher degree of freedom, considers that a velocity direction and a heading angle of the object are not always consistent with each other, and introduces a front wheel angle and a sideslip angle to describe a motion state of the object. In order to reduce the model complexity, it is assumed that the velocity and the front wheel angle of the object keep unchanged. The cyclists motion model takes structural rigidity of the object into consideration, and therefore, an obvious coupling relationship exists between the motion parameters, so as to be able to better reflect highly nonlinear motion characteristics of cyclists, as shown in FIG. 6(c). State variables and a state transition equation of a cyclists trajectory is represented as:

$${}_{}^{BIC} {X}_{k + 1}^{} = {}_{}^{BIC} {{X}_{k}^{}}^{} + [ \begin{matrix}{v}_{k} {T}_{k} cos ( {θ}_{k} + β ) \\ {v}_{k} {T}_{k} sin ( {θ}_{k} + β ) \\ \frac{{v}_{k} {T}_{k}}{{l}_{r} + {l}_{f}} cos ( β ) tan ( δ ) \\ 0 \\ 0 \\ 0\end{matrix} ] \qquad ( 14 )$$

In the equation, ^{BIC}X represents a state parameter of the cyclists motion model, β and δ represent the sideslip angle and the front wheel angle of the car, and I_{f} and Iᵣ represent distances from a front wheel and a rear wheel of the car to a center of mass of the car, respectively;

The quadratic motion models are all nonlinear, and Kalman filtering is no longer applicable. Therefore, the present disclosure further introduces Unscented Kalman Filtering to predict a future state of the trajectory. A prediction process is represented as:

$${X}_{k + 1} = f ( {X}_{k} , {v}_{k} ) , {Z}_{k + 1} = h ( {X}_{k + 1} ) + {w}_{k + 1} \qquad ( 15 )$$

$${X}_{k + 1 \vert k + 1} = {X}_{k + 1 \vert k} + {K}_{k + 1 \vert k} ( {Z}_{k + 1} - {Z}_{k + 1 \vert k} ) \qquad ( 16 )$$

In the equations, f(·) and h(·) represent a state transition equation and a state prediction equation, respectively, and vᵢ and wᵢ represent Gaussian noise, Xᵢ and Zᵢ represent a motion state variable and an observation state variable, respectively, i=k or k+1 represents time, K_{k+1|k} represents a Kalman gain, and X_{k+1|k+1}, X_{k+1|k}, and Z_{k+1|k} represent a lossless Kalman prediction value, a motion model prediction value, and an observation model observation value of the trajectory, respectively;

The multiple categories of traffic participants have different motion characteristics, and have diversified adaptabilities to cost functions and association thresholds. Therefore, the present disclosure sets a simple category filter to perform intra-class association between multi-category objects and trajectories. Further, the present disclosure uniformly evaluates similarities of motion states by using a G-IoUBEV having comprehensive performance as a cost function. The G-IoUBEV is represented as:

$${S}_{U} = {S}_{{B}_{1}} + {S}_{{B}_{2}} - {S}_{I} \qquad ( 17 )$$

$$G - {IoU}_{BEV} ( {B}_{1} , {B}_{2} ) = {S}_{I} / {S}_{U} - ( {S}_{C} - {S}_{U} ) / {S}_{C} \qquad ( 18 )$$

In the equations, S_{U}, S_{B}_{₁}, S_{B}_{₂}, S_{I}, and S_{C} represent an area of a union of a bounding box of current frame detection results and a bounding box of trajectory prediction results, an area of the bounding box of the current frame detection results, an area of the bounding box of the trajectory prediction results, an area of an intersection of the bounding box of the current frame detection results and the bounding box of the trajectory prediction results, and an area of an enclosing convex polygon of the union of the bounding box of the current frame detection results and the bounding box of the trajectory prediction results.

Furthermore, the present disclosure sets different thresholds for multi-category data association to adapt to the motion characteristics of the traffic participants. After the first-level data association is completed, the remaining small number of unmatched detections and trajectories are sent to the second-level data association for further matching.

Next, the second-level data association module based on multi-modal temporal memory appearance features is established. In fact, in complex traffic scenarios, the motion characteristics of some traffic participants are not significant. According to a social force model, the object is influenced by social fields such as road environments, traffic rules, and mutual interference to change its own motion state. In this case, the movement state of the object reflects more sociality rather than motion characteristics. In other words, the previously constructed motion model is no longer applicable, and the future state of the object cannot be accurately predicted by relying solely on spatial motion information. In addition, the social force model focuses on describing group movements and is difficult to quantify movement states of microcosmic individuals. Therefore, the present disclosure additionally introduces multi-modal appearance features as the basis for the second-level data association, thereby further associating the remaining unmatched detections and trajectories.

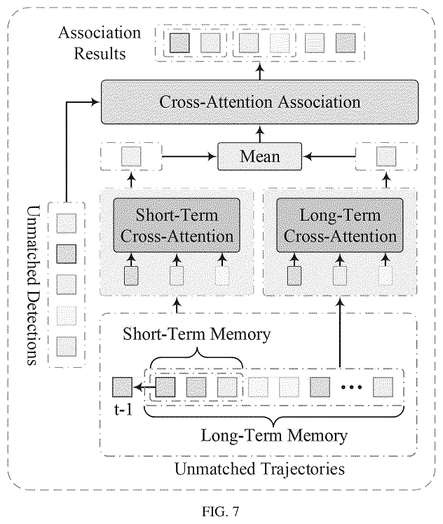

Specifically, the present disclosure constructs an aggregation network of multi-modal temporal memory appearance features for encoding temporal features, thereby achieving data association through cross-modal attention. The detailed structure of the second-level data association network based on multi-modal temporal memory appearance features is shown in FIG. 7. First, a temporal memory register is set to store appearance features of all trajectories over a period of time. In order to reduce the data storage pressure, the appearance features in the register meet a “first-in first-out” principle. Next, long- and short-term memory aggregated features are further calculated for unmatched trajectories in the first-level data association module. Frames adjacent to a current frame (including the current frame) are defined as short-term memory, and all frames stored in the register are defined as long-term memory. Short-term and long-term temporal appearance features are encoded respectively by short-term cross-modal attention and long-term cross-modal attention. The current frame feature is used as a query, while the short-term memory and the long-term memory are used as a key and a value. Finally, a mean of the short-term and long-term temporal appearance features obtained from encoding is calculated, to obtain final long- and short-term memory aggregated features. The encoding and aggregation processes is expressed as:

$${App}_{s} = Attn ( {Q}^{t - 1} , {Q}^{t - 1 - {T}_{s} : t - 1} , {Q}^{t - 1 - {T}_{s} : t - 1} ) \qquad ( 19 )$$

$${App}_{l} = A t t n ( {Q}^{t - 1} , {Q}^{t - 1 - {T}_{l} : t - 1} , {Q}^{t - 1 - {T}_{l} : t - 1} ) \qquad ( 20 )$$

$${App}_{agr} = Mean ( {App}_{s} + {App}_{l} ) \qquad ( 21 )$$

In the equations, Appₛ, Appₗ, and App_{agr} represent the short-term memory appearance features, the long-term memory appearance features, and the long- and short-term memory aggregated appearance features, respectively; Q^{t-1}, Q^{t-1-T}^{ₛ}^{:t-1}, and Q^{t-1-T}^{ₗ}^{:t-1} represent historical frame query features, short-term memory query features, and long-term memory query features, respectively; and Attn and Mean represent attention and arithmetic mean computations, respectively.

The appearance features of the object vary along with the observation angle and real-time changes in the scenario, so that they are difficult to predict. However, their colors or structural features often remain consistent overall. Therefore, the present disclosure sets the long-term and short-term attentions to capture temporal variation information as much as possible, thereby achieving aggregation to obtain comprehensive appearance features. Finally, the cross-modal attention is applied to match the appearance features of the detections and trajectories one by one, evaluate similarities between the detections and the trajectories, and perform data association based on a threshold.

After completing the second-level data association, the final matching result is sent to the trajectory management module. For successfully matched trajectories, based on lossless Kalman filtering, a detection of the current frame is used as posterior updated trajectory state information. For unmatched detections, trajectory initialization is performed after reaching a minimum hit count. For unmatched trajectories, the trajectory state information is updated using prediction results of a quadratic motion model, and trajectory death processing is performed after reaching a maximum lifecycle.

In summary, the cascade coupling data association strategy of motion-appearance features objectively classifies trajectories into two categories, that is, those with significant motion characteristics and those with significant social characteristics, and uses spatial state information and multi-modal appearance features respectively as the basis for data association. The present disclosure sets a high threshold for first-level data association based on multi-category multi-model state prediction (a threshold range is [−1, 1], and the higher value is generally set at −0.4 or −0.3). While avoiding erroneous matching caused by low-precision motion state prediction, socially significant objects are selected as much as possible, thereby further completing matching in the second-level data association based on multi-modal temporal memory appearance features. The two matching processes are complementary to each other, thereby achieving efficient utilization of spatial motion information and multi-modal appearance features as much as possible.

The series of detailed explanations listed above are only specific descriptions of the feasible implementations of the present disclosure, and they are not intended to limit the scope of protection of the present disclosure. Equivalent methods or modifications that do not depart from the technical aspects of the present disclosure should be included within the scope of protection of the present disclosure.

1. A high-performance loosely coupled multi-modal data fusion system for an intelligent driving environment perception system, comprising a fusion detection model based on a modal-specific feature interaction strategy, configured to convert LiDAR point clouds, camera images, and millimeter-wave radar point clouds into unified bird's-eye view (BEV) features and perform multi-modal fusion; and
a fusion tracking model based on a cascade coupling data association strategy of motion-appearance features, configured to perform subsequent trajectory tracking and matching based on feature information of the multi-modal fusion provided by the fusion detection model,
wherein the fusion tracking model based on the cascade coupling data association strategy of the motion-appearance features comprises a consecutive-frame multi-modal appearance feature generation module, a first-level data association module based on multi-category multi-model state prediction, a second-level data association module based on multi-modal temporal memory appearance features, and a trajectory management module; the fusion tracking model adopts tracking-by-detection (TBD) architecture and does not require an additional appearance feature extractor.

2. The high-performance loosely coupled multi-modal data fusion system for the intelligent driving environment perception system according to claim 1, wherein the fusion detection model based on the modal-specific feature interaction strategy comprises a multi-modal feature extraction and BEV feature generation module, a modal-specific object queries initialization module, and a multi-modal feature fusion module based on a deformable Transformer; and the fusion detection model is constructed based on detection transformers (DETR) architecture, and supervised training is performed using bipartite graph optimal matching cost.

3. The high-performance loosely coupled multi-modal data fusion system for the intelligent driving environment perception system according to claim 2, wherein the multi-modal feature extraction and BEV feature generation module is configured to uniformly convert multi-modal features into a shared BEV space, with multi-modal information remaining independent of each other in a feature extraction process, comprising:
processing the LiDAR point clouds by applying a voxelization method, wherein original LiDAR point clouds are subjected to dynamic voxelization first, step-by-step feature extraction is performed by using three-dimensional (3D) sparse convolution to obtain 3D voxel features, non-empty voxel features are then compressed in a height direction, and finally feature extraction is performed by using two-dimensional (2D) convolution to obtain dense point cloud BEV features, with a process expressed as:
$${F}_{lid} = Voxelize ( {PC}_{lid} ) ∘ SPConv ∘ Aggn ∘ Conv \qquad ( 1 )$$
wherein, ∘ represents a cascade operation, and PC_{lid} represents the original LiDAR point clouds; and Voxel, SPConv, Aggn, and Conv represent the dynamic voxelization, the 3D sparse convolution, feature aggregation, and the 2D convolution, respectively;
converting camera foreground images into BEVs, wherein a VoVNet is used first to perform feature extraction on the camera foreground images to obtain multi-scale image features; a Lift network is then used to predict discrete depth distribution of the multi-scale image features and convert the multi-scale image features into discretized frustum features; and finally, height information is compressed using frustum pooling to obtain image BEV features, with a process expressed as:
$${F}_{cam} = VoVNet ( Img ) ∘ DepthPred ∘ PillarPool \qquad ( 1 )$$
wherein, lmg represents an image of a multi-view visible-light camera; and VoVNet, DepthPred, and FrustPool represent a VoVNet-57 feature extraction backbone, a Lift depth prediction network, and a frustum pooling kernel, respectively; and
converting four-dimensional (4D) radar point clouds to BEVs, wherein original radar point clouds are converted into 2D pseudo images by pillarization first; a neighborhood Transformer is then used to perform feature extraction on the 2D pseudo images to obtain dense radar features; and a ResNet is finally used to adjust scales of the dense radar features so that the dense radar features maintain spatial semantic consistency with LiDAR features, with a process expressed as:
$${F}_{r a d} = Pillarize ( {PC}_{r a d} ) ∘ NAT ∘ ResNet \qquad ( 2 )$$
wherein, PC_{rad} represents the millimeter-wave radar point clouds, and Pillarize, NAT, and ResNet represent the pillarization, a neighborhood Transformer feature extraction backbone, and a residual backbone network, respectively.

4. The high-performance loosely coupled multi-modal data fusion system for the intelligent driving environment perception system according to claim 2, wherein the modal-specific object queries initialization module is configured to parallelly feed multi-modal BEV features obtained by the multi-modal feature extraction and BEV feature generation module into an occupancy prediction network to obtain multi-modal heatmaps, wherein the multi-modal BEV features and the multi-modal heatmaps are only stacked in form and remain independent of each other during processing; and select, by setting a threshold, high response zones with confidence levels higher than the threshold in the multi-modal heatmaps to be regarded as candidate zones, wherein the candidate zones, during construction of object query embedding, are classified into position embedding and content embedding, the multi-modal candidate zones comprise spatial position information of potential objects, and the spatial position information is encoded into the position embedding through a multi-layer perceptron, with a process expressed as:
$$P E = C o n c a t ( {F}_{lid} , {F}_{cam} , {F}_{r a d} ) ∘ O c c P r ed ∘ MLP \qquad ( 3 )$$
wherein, F_{lid}, F_{cam}, and F_{rad} represent LiDAR point cloud BEV features, multi-view camera image BEV features, and millimeter-wave radar BEV features, respectively, and Concat, OccRed, and MLP represent a concatenation operation, an occupancy grid prediction network, and the multi-layer perceptron, respectively;
for the content embedding, a modality of the candidate zones is defined as a primary modality, other two modalities are defined as secondary modalities, corresponding multi-modal BEV features are first indexed based on coordinates of the candidate zones; two attention mechanisms are then used in parallel to process features of the secondary modalities, wherein a feature of the primary modality is used as an object query, the features of the secondary modalities are used as keys and values, and by global matching of the object query with the keys, potential effective information in the secondary modalities is selected; and finally, the content embedding is obtained by stacking a primary feature and processed secondary features and performing dimensionality reduction mapping;
initial object query embedding is obtained by element-wise addition performed on the position embedding and the content embedding, with a process expressed as:
$${F}_{{s}_{1}} = softmax ( \frac{{Q}_{m} {K}_{{s}_{1}}^{T}}{\sqrt{d}} ) {V}_{{s}_{1}} , {F}_{{s}_{2}} = softmax ( \frac{{Q}_{m} {K}_{{s}_{2}}^{T}}{\sqrt{d}} ) {V}_{{s}_{2}} \qquad ( 4 )$$
$$C E = Co n c a t ( {F}_{m} , {F}_{{s}_{1}} , {F}_{{s}_{2}} ) ∘ FFN \qquad ( 5 )$$
$$QE = CE + P E \qquad ( 6 )$$
wherein, Qₘ represents the object query of the primary modality, and Kₛ₁, Kₛ₂, Vₛ₁, and Vₛ₂ represent the keys and the values of the other two secondary modalities, respectively; Fₘ represents the feature of the primary modality, and Fₛ₁ and Fₛ₂ represent the features obtained for the secondary modalities; CE, PE, and QE represent the content embedding, the position embedding, and the object query embedding, respectively; and FFN represents a feed forward neural network.

5. The high-performance loosely coupled multi-modal data fusion system for the intelligent driving environment perception system according to claim 2, wherein the multi-modal feature fusion module based on the deformable Transformer is configured to:
stack multi-modal BEV features obtained by the multi-modal feature extraction and BEV feature generation module; and further select and integrate the multi-modal BEV features by using an encoder to obtain lightweight multi-modal fusion features, wherein the encoder adopts a multi-modal deformable attention mechanism to perform adaptive weighted summation on sample features of all modalities, to aggregate multi-modal features; and multi-modal deformable attention is expressed as:
$$MMDeformAttn ( {p}_{q} , {F}_{com} ) = {\sum }_{i = 1}^{N} {W}_{i} [ {\sum }_{m = 1}^{M} {\sum }_{k = 1}^{K} {A}_{i m q k} \cdot {W}^{′} {F}_{com} ( {p}_{q} + Δ {p}_{i m q k} ) ] \qquad ( 7 )$$
wherein, p_{q} and F_{com} represent normalized sampling point coordinates and multi-modal stacked BEV features, respectively; Wᵢ and W′ represent a normalized weight of multi-branch attention and a normalized sampling point weight, respectively; i, m, and k represent a multi-branch attention sequence number, a modality sequence number, and a sampling point sequence number, respectively; N, M, and K represent a total number of branches of the multi-branch attention, a total number of modalities, and a total number of sampling points, respectively, Δp_{imqk} and A_{imqk} represent a sampling point offset and a BEV feature weight of a corresponding sequence number combination, respectively, and the weights need to be globally normalized.

6. (canceled)

7. The high-performance loosely coupled multi-modal data fusion system for the intelligent driving environment perception system according to claim 1, wherein the first-level data association module based on the multi-category multi-model state prediction is configured to introduce a plurality of quadratic nonlinear motion models to establish accurate motion models for different categories of traffic participants, comprising:
based on a statistical distribution pattern of motion characteristics of the traffic participants, selecting quadratic motion models with highest adaptability, and introducing a Constant Turn Rate and Velocity (CTRV) model, a Constant Turn Rate and Acceleration (CTRA) model, and a cyclists motion model, wherein the CTRV model assumes that an object moves along a straight line and is also able to move at a fixed turn rate and a constant velocity, a velocity direction and a heading angle of the object in the CTRV model are always consistent with each other, and motion characteristics of pedestrians are comprehensively reflected, wherein a state transition equation of a pedestrian trajectory is represented as:
$${}^{CTRV} {X}_{k + 1} = {}^{CTRV} {X}_{k} + [ \begin{matrix}\frac{v}{ω} [ sin ( {θ}_{k} + ω {T}_{k} ) - sin ( {θ}_{k} ) ] \\ \frac{v}{ω} [ cos ( {θ}_{k} ) - cos ( {θ}_{k} + ω {T}_{k} ) ] \\ ω {T}_{k} \\ 0 \\ 0\end{matrix} ] \qquad ( 9 )$$
wherein, ^{CTRV}X represents a state parameter of a pedestrian motion model; θ, v, and ω represent a heading angle of a car, a car velocity, and an angular velocity, respectively, and Tₖ represents a time interval;
as a further development on a basis of the CTRV model, the CTRA model assumes that the object moves at a fixed turn rate and a constant acceleration, considers that an acceleration direction, a velocity direction, and a heading angle of the object are always consistent with one another, and has motion characteristics more in line with car objects, wherein state variables and a state transition equation of a car object trajectory are represented as:
$${}^{CTRA} {X}_{k + 1} = {}^{CTRA} {X}_{k} + [ \begin{matrix}{g}_{x} ( {x}_{k} , {T}_{k} ) \\ {g}_{y} ( {x}_{k} , {T}_{k} ) \\ {ωΓ}_{k} \\ a {T}_{k} \\ 0 \\ 0\end{matrix} ] \qquad ( 10 )$$
$${g}_{x} = \frac{a [ cos ( {θ}_{k} + ω {T}_{k} ) - cos ( {θ}_{k} ) ]}{{ω}^{2}} + \frac{( {v}_{k} + a {T}_{k} ) sin ( {θ}_{k} + ω {T}_{k} ) - {v}_{k} sin ( {θ}_{k} )}{ω} \qquad ( 11 )$$
$${g}_{y} = \frac{a [ sin ( {θ}_{k} + ω {T}_{k} ) - sin ( {θ}_{k} ) ]}{{ω}^{2}} - \frac{( {v}_{k} + a {T}_{k} ) cos ( {θ}_{k} + ω {T}_{k} ) - {v}_{k} cos ( {θ}_{k} )}{ω} \qquad ( 12 )$$
wherein, C^{TRA}X represents a state parameter of a cars motion model, gₓ(xₖ,Tₖ) and g_{y}(xₖ,Tₖ) represent intermediate variables, and a represents an object acceleration; and
the cyclists motion model considers that the velocity direction and the heading angle of the object are not always consistent with each other, and introduces a front wheel angle and a sideslip angle to describe a motion state of the object; assuming that a velocity and the front wheel angle of the object keep unchanged, the cyclists motion model takes structural rigidity of the object into consideration, and an obvious coupling relationship exists between motion parameters, so that highly nonlinear motion characteristics of cyclists are reflected better, wherein state variables and a state transition equation of a cyclists trajectory are represented as:
$${}^{BIC} {X}_{k + 1} = {}^{BIC} {X}_{k} + [ \begin{matrix}{v}_{k} {T}_{k} cos ( {θ}_{k} + β ) \\ {v}_{k} {T}_{k} sin ( {θ}_{k} + β ) \\ \frac{{v}_{k} {T}_{k}}{{l}_{r} + {l}_{f}} cos ( β ) tan ( δ ) \\ 0 \\ 0 \\ 0\end{matrix} ] \qquad ( 13 )$$
wherein, ^{BIC}X represents a state parameter of the cyclists motion model, β and δ represent the sideslip angle and the front wheel angle of the car, and I_{f} and Iᵣ represent distances from a front wheel and a rear wheel of the car to a center of mass of the car, respectively;
introducing Unscented Kalman Filtering to predict a future state of a trajectory, wherein a prediction process is represented as:
$${X}_{k + 1} = f ( {X}_{k} , {v}_{k} ) , {Z}_{k + 1} = h ( {X}_{k + 1} ) + {w}_{k + 1} \qquad ( 14 )$$
$${X}_{k + 1 \vert k + 1} = {X}_{k + 1 \vert k} + {K}_{k + 1 \vert k} ( {Z}_{k + 1} - {Z}_{k + 1 \vert k} ) \qquad ( 15 )$$
wherein, f(·) and h (·) represent a state transition equation and a state prediction equation, respectively, vᵢ and wᵢ represent Gaussian noise, Xᵢ and Zᵢ represent a motion state variable and an observation state variable, respectively, i=k or k+1 represents time, K_{k+1|k} represents a Kalman gain, and X_{k+1|k+1}, X_{k+1|k}, and Z_{k+1|k} represent a lossless Kalman prediction value, a motion model prediction value, and an observation model observation value of the trajectory, respectively;
setting a category filter to perform intra-class association between multi-category objects and trajectories, and uniformly evaluating similarities of motion states by using a G-IoUBEV having comprehensive performance as a cost function, wherein the G-IoUBEV is represented as:
$${S}_{U} = {S}_{{B}_{1}} + {S}_{{B}_{2}} - {S}_{I} \qquad ( 16 )$$
$$G - {IoU}_{BEV} ( {B}_{1} , {B}_{2} ) = {S}_{I} / {S}_{U} - ( {S}_{C} - {S}_{U} ) / {S}_{C} \qquad ( 17 )$$
wherein, S_{U}, S_{B}, S_{B}, S_{B}, Sₗ and S_{C} represent an area of a union of a bounding box of current frame detection results and a bounding box of trajectory prediction results, an area of the bounding box of the current frame detection results, an area of the bounding box of the trajectory prediction results, an area of an intersection of the bounding box of the current frame detection results and the bounding box of the trajectory prediction results, and an area of an enclosing convex polygon of the union of the bounding box of the current frame detection results and the bounding box of the trajectory prediction results; and
setting different thresholds for multi-category data association to adapt to the motion characteristics of the traffic participants.

8. The high-performance loosely coupled multi-modal data fusion system for the intelligent driving environment perception system according to claim 1, wherein the second-level data association module based on the multi-modal temporal memory appearance features is configured to: first set a temporal memory register to store appearance features of all trajectories over a period of time; then calculate long- and short-term memory aggregated features for unmatched trajectories in the first-level data association module, wherein frames adjacent to a current frame (comprising the current frame) are defined as short-term memory, and all frames stored in the register are defined as long-term memory; next, encode short-term and long-term temporal appearance features, respectively by short-term cross-modal attention and long-term cross-modal attention, wherein the current frame feature is used as a query, and the short-term memory and the long-term memory are used as a key and a value, respectively; next, calculate a mean of the short-term and long-term temporal appearance features obtained from encoding, to obtain final long- and short-term memory aggregated features, wherein encoding and aggregation processes are expressed as:
$${App}_{s} = A t t n ( {Q}^{t - 1} , {Q}^{t - 1 - {T}_{s} : t - 1} , {Q}^{t - 1 - {T}_{s} : t - 1} ) \qquad ( 18 )$$
$${App}_{l} = A t t n ( {Q}^{t - 1} , {Q}^{t - 1 - {T}_{l} : t - 1} , {Q}^{t - 1 \text{-} {T}_{l} : t - 1} ) \qquad ( 19 )$$
$${App}_{a g r} = Mean ( {App}_{s} + {App}_{l} ) \qquad ( 20 )$$
wherein, Appₛ, Appₗ, and App_{agr} represent short-term memory appearance features, long-term memory appearance features, and long- and short-term memory aggregated appearance features, respectively; Q^{t-1}, Q^{t-1-t}^{ₛ}^{:t-1}, and Q^{t-1-T}^{ₗ}^{:t-1} represent historical frame query features, short-term memory query features, and long-term memory query features, respectively; and Attn and Mean represent attention and arithmetic mean computations, respectively; and
finally apply cross-modal attention to match appearance features of detections and trajectories, evaluate similarities between the detections and the trajectories, and perform data association based on a threshold.

9. The high-performance loosely coupled multi-modal data fusion system for the intelligent driving environment perception system according to claim 1, wherein the trajectory management module is configured to: for successfully matched trajectories, based on lossless Kalman filtering, use a detection of a current frame as posterior updated trajectory state information; for unmatched detections, perform trajectory initialization after reaching a minimum hit count; and for unmatched trajectories, update the trajectory state information by using prediction results of a quadratic motion model, and perform trajectory death processing after reaching a maximum lifecycle.

10. Intelligent driving on-board equipment, wherein the fusion detection model based on the modal-specific feature interaction strategy and the fusion tracking model based on the cascade coupling data association strategy of the motion-appearance features according to claim 1 are deployed in the intelligent driving on-board equipment.
